(19) United States
(12) Patent Application Publication
(10) Pub. No.: US 2011/0264546 A1
(43) Pub. Date: Oct. 27, 2011

(54) METHOD AND SYSTEM TO AUTOMATICALLY ASSIGN A WEIGHT CLASS ON AN ITEM LISTED FOR SALE ONLINE BY A SELLER

(75) Inventor: Suzanne M. Turner-Rielle, Midland, MI (US)

(73) Assignee: RIELLE LIFE LLC, Midland, MI (US)

(21) Appl. No.: 13/093,124

(22) Filed: Apr. 25, 2011

Related U.S. Application Data
(60) Provisional application No. 61/328,273, filed on Apr. 27, 2010.

(51) Int. Cl. G06Q 30/00

(52) U.S. Cl. 705/26.1

(57) ABSTRACT

A method and system for automatically determining the weight class of an item sold via an electronic commerce system and to be shipped are disclosed. The weight class can then be used to determine a shipping cost. This helps a seller to determine a fair and reasonable shipping charge for an item without the need to weigh it or access shipping rate charts.

### BACKGROUND OF THE INVENTION

1. Field of the Invention

This invention pertains in general to electronic commerce and in particular to a method and system for recommending a weight class for an item to be sold via an electronic commerce system.

2. Description of the Related Art

Today, electronic commerce on the internet has become commonplace. There are many merchants offering goods and services on web sites on the internet, and there are an even greater number of customers who purchase the goods and services. In many cases, the electronic commerce transaction involves physical goods. When the physical goods are purchased, those goods need to be shipped to the purchaser.

Of course, there is a price associated with shipping an item that is sold via an electronic commerce marketplace. When the seller is a retailer of many items of the same type, the seller usually affixes a barcode to the item that contains details describing and identifying the item, as described in WO 2010/016917. Often, retailers also have automated processes for generating shipping labels and other aspects of the shipping process, once the weight of the item is already known, as described in U.S. 2004/114089, and U.S. Pat. No. 7,050 938.

For consumer-to-consumer transactions, the consumer is usually faced with having to weigh the item that they desire to sell, and then inputting that weight in order to determine a shipping price, as described in, for example, U.S. 2010/0036777. There are processes for categorizing the identity of the item itself in such consumer-to-consumer transactions (see, for example, U.S. 2007/0150365), but this process does not assist a seller in determining the weight of the item the seller desires to sell.

None of the above cited prior art describes a method or system for automatically recommending a weight or weight classification in order to determine shipping charges for an item to be sold via an electronic commerce marketplace.

### SUMMARY OF THE INVENTION

In one aspect, the present invention is a method of conducting electronic commerce comprising: using a computer to perform steps comprising: receiving a listing for an item for sale on a website, the item having one or more item attributes associated with it; and automatically determining a weight class for the item based on the one or more item attributes.

In another aspect, the present invention is an electronic commerce system having a computer-readable storage medium having computer-executable code, the computer-executable code comprising: a listed item; an item attribute database; and a weight class assignment module that communicates with the item attribute database to determine and assign a weight class for the listed item.

The present invention allows for the automatic recommendation of a weight class for an item to be sold via an electronic commerce system. The weight class can then be used to determine a shipping cost. This helps a seller to determine a fair and reasonable shipping charge for an item without the need to weigh it, access shipping rate charts, and/or determine a shipping cost.

### BRIEF DESCRIPTION OF THE DRAWINGS

FIG. 1 illustrates a schematic diagram for one embodiment of a system of the present invention.

### DETAILED DESCRIPTION OF SPECIFIC EMBODIMENTS

One specific embodiment of the present invention will now be described with reference to the drawings. This embodiment is intended to illustrate, and not limit, the present invention. The scope of the invention is defined by the claims.

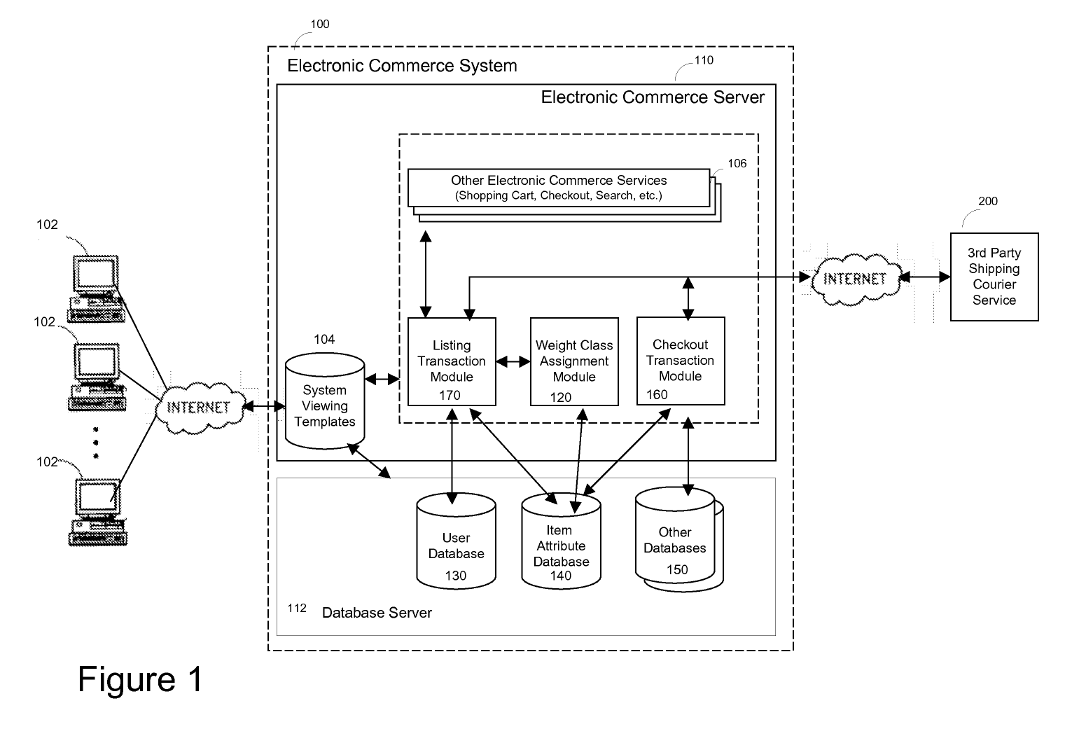

FIG. 1 illustrates the components of an electronic commerce system 100 that implements a

Shipping Weight Class service according to one embodiment of the invention. The system 100 includes a electronic commerce server 110 that services requests from user computerized devices 102 (PC's, PDA's, web-enabled phones, web-enabled electronic reading devices and tablets, other mobile devices, etc.) over the internet.

These devices allow a user to list a item for sale on the electronic commerce system for available items listed for sale. When an item is listed for sale, it is herein referred to as the item's “listing”. The term “sale” is defined herein to mean an exchange of goods for some form of consideration having approximately equal value, including sale for any amount of cash (including zero), swapping, trading, exchanging goods for credit, and other similar transactions.

The method and system of the present invention are particularly suitable for items that are unique, one-of-a-kind, or of limited availability. The term “item”, also referred to herein as “unique item” means a unique, one-of-a-kind piece of merchandise, which can be one individual article or which may be a grouping of more than one article. It has specific characteristics and identifier associated with it, and there is or may be only one available. Such items may include, for example, physical products, such as apparel, books, DVD's, and other consumer products.

The term “seller” as used herein means the consumer involved in the specific transaction being described as a “sale” of the item. The term “sale”, meaning distribution of items for some form of consideration having approximately equal value, including cash (including zero), swapping, trading, exchanging goods for credit, and other similar transactions. The term “user” as used herein means the seller but also consumers other than the seller. A user can be classified as a “visitor” or as a “registered member”. A “visitor” is defined as being a guest or someone who does not register with the website. Visitors can shop without registering. If the user is a “registered member”, it means they have provided requested personal information and have received a user name and password to log in to the site, have an account and are able to list items for sale under that account. The term “registered member” is not intended to be limiting, and terms such as “registered user” or “frequent user” or other similar term may be used to describe this type of user, so long as the term represents a user that receives a login name and password to the website. The term “buyer” herein meaning any customer of the electronic commerce service, whether a visitor or a registered member, who is involved in the specific transaction of a purchase of an item from a seller using cash (including zero), swapping, trading, credit or credits, and other similar transactions.

Referring again to FIG. 1, the Database Server 112 contains an Item Attribute Database 140 of information and attributes about items that are available for purchase. One of the attributes stored for each item is a Weight Class. When a user views an item's listing, the attribute of Weight Class may or may not be visible to the user. Other attributes that may be associated with an item in the Item Attribute Database 140 and viewable by a user include, but are not limited to, the item's listing category, type, brand name or manufacturer, size, color, material or fabric, condition, detailed description, images, and price.

In this invention, the attribute of Weight Class is automatically determined by a Weight Class Assignment Module 120 that stores parameters for determining and assigning an item's Weight Class by specific item attributes. In the case of an item of clothing, for example, it is important for the Weight Class Assignment Module 120 to utilize the attributes of the item's type (or type of clothing) and the item's size. Other optional attributes may be useful in determining and assigning the Weight Class of an item, such as the materials or fabric from which the item is made and the estimated weight of the packaging materials required for shipping the item.

Weight Class assignments, as determined by the Weight Class Assignment Module 120 can be represented as specific weights or as a weight range, such as, for example, a Weight Class of ‘1’ equaling a range of actual weight between 0.1 ounces and 6 ounces, a Weight Class of ‘2’ equaling a range of actual weight between 6.1 ounces and 13 ounces, and so forth into ranges of multiples pounds and ounces. The actual weight ranges may vary.

The parameters of the Weight Class assignments, as determined by the Weight Class Assignment Module 120 are preferably aligned with the pricing mechanism used for one or more selected shipping courier services. The calculation of actual shipping costs may be determined within the System 100 or via an electronic interface with a Third Party Shipping Courier Service 200, as shown in FIG. 1. Shipping courier services standardly use a packaged item's weight as one of the inputs for calculating actual shipping costs, along with other factors like package dimensions and the “to” and “from” shipping addresses. When a Weight Class represents of range of weights, the system 100 further specifies the specific weight to be used for calculating actual shipping charges through the Third Party Shipping Courier Service 200.

The Weight Class Assignment Module 120 in this embodiment assigns the Weight Class while the Seller is listing an item for sale and before they submit item listing for storage in the Item Attribute Database 140 via the Listing Transaction Module 170. Optionally the Weight Class may be assigned after the Seller submits the listing for the item. Also, optionally, the Listing Transaction Module 170 may require the use of the Weight Class assigned by the Weight Class Assignment Module 120 or allow the seller to disregard the weight class assignment generated by the system. In this manner the Seller will override the automatically generated Weight Class assignment with a manually-entered Weight Class of their preference.

The Weight Class assigned by the Weight Class Assignment Module 120 and stored with the item in the Item Attribute Database 140 may be viewed by a user prior to commitment to purchase an item and/or may be used in a Checkout Module 160 to calculate the actual shipping costs to be included on the order for the item.

The Checkout Module 160 can also logically be programmed to manage the shipping costs of multiple items on a single order by calculating the summation of weights represented by the Weight Classes on each item included in the order to communicate a total weight to a shipping courier service for the purposes of calculating the total shipping charge to be applied to the order.

1. A method of conducting electronic commerce comprising:
using a computer to perform steps comprising:
a) receiving a listing for an item for sale on a website, the item having one or more item attributes associated with it;
b) automatically assigning a weight class for the item based on the one or more item attributes.

2. The method of claim 1, further comprising the step of:
c) presenting the determination in step b) to a buyer of the item, a seller of the item, or both the buyer and the seller of the item.

3. The method of claim 1, wherein the weight class in step b) is aligned with the pricing mechanism used for one or more selected shipping courier services.

4. The method of claim 3, further comprising:
d) determining the postage amount for the item based at least in part on the weight class determined in step b) and the selected courier service pricing mechanism.

5. The method according to any of claim 1, wherein the item is an article of clothing.

6. The method according to claim 5, wherein the attributes for the item are selected from the group consisting of type of clothing, size, fabric, and other item attributes that contribute to the actual weight of an item.

7. An electronic commerce system having a computer-readable storage medium having computer-executable code, the computer-executable code comprising:
a listed item;
an item attribute database;
a weight class assignment module that communicates with the item attribute database to determine and assign a weight class for the listed item.

8. The system of claim 7 where in the item attribute database includes one or more attributes associated with items that may be listed.

9. The system of claim 7, wherein the listed item is an article of clothing.

10. The system of claim 9, wherein the item attribute database includes attributes consisting essentially of type of clothing, size, fabric, and other item attributes that contribute to the actual weight of an item.
